(19) United States
(12) Patent Application Publication
(10) Pub. No.: US 2013/0098806 A1
(43) Pub. Date: Apr. 25, 2013

(54) BITUMEN FROTH TREATMENT SETTLER FEED DISTRIBUTOR

(71) Applicant: SHELL OIL COMPANY, Houston, TX (US)

(72) Inventors: Elco Dick HOLLANDER, Amsterdam (NL); John Khai Quang DIEP, Edmonton (CA); Darwin Edward KIEL, New Westminister (CA); Yicheng LONG, Calgary (CA)

(73) Assignee: SHELL OIL COMPANY, Houston, TX (US)

(21) Appl. No.: 13/655,572

(22) Filed: Oct. 19, 2012

Related U.S. Application Data
(60) Provisional application No. 61/550,160, filed on Oct. 21, 2011.

(51) Int. Cl. F03B 11/02; C10G 1/04

(52) U.S. Cl. 208/391; 137/561 R

(57) ABSTRACT

A feed distributor for a settler is provided, the settler effective for separating a solvent-diluted bitumen froth into a water/solids stream and a hydrocarbon stream, the feed distributor comprising: an inlet conduit effective to route bitumen froth into the settler; and an essentially horizontal plate attached to a lower extremity of the inlet conduit and wherein the inlet conduit defines openings through which the solvent-diluted bitumen froth can pass from inside the inlet conduit to a volume above the essentially horizontal plate.

### CROSS-REFERENCE TO RELATED APPLICATION

This application claims the benefit of U.S. Provisional Application No. 61/550,160, filed on 21 Oct. 2011, which is incorporated herein by reference.

### FIELD OF THE INVENTION

The invention relates to a method and apparatus for distribution of feed into a setter in a bitumen froth treatment system in a process to separate solvent-diluted bitumen from mineral solids, and water.

### BACKGROUND

Oil sand is essentially a matrix of bitumen, mineral material and water, and possibly encapsulated air. The bitumen component of oil sand consists of viscous hydrocarbons which behave much like a solid at normal in situ temperatures and which act as a binder for the other components of the oil sand matrix. Oil sand will typically contain about 10% to 12% bitumen and about 3% to 6% water, with the remainder of the oil sand being made up of mineral matter. The mineral matter component in oil sand may contain about 14% to 20% fines, measured by weight of total mineral matter contained in the deposit, but the amount of fines may increase to about 30% or more for poorer quality deposits. Oil sand extracted from the Athabasca area near Fort McMurray, Alberta, Canada, averages about 11% bitumen, 5% water and 84% mineral matter, with about 15% to 20% of the mineral matter being made up of fines. The shallow oil sand deposits are mined for the purpose of extracting bitumen from them, which is then upgraded to synthetic crude oil. A widely used process for extracting bitumen from oil sand is the “water process”. In this process, both aggressive thermal action and aggressive mechanical action are used to liberate and separate bitumen from the oil sand. An example of the water process is the hot water process. In the hot water process, oil sand is first conditioned by mixing it with hot water at about 95.degree. Celsius and steam in a conditioning vessel which vigorously agitates the resulting slurry in order to disintegrate the oil sand. Once the disintegration of the oil sand is complete, the slurry is separated by allowing the sand and rock to settle out. Bitumen, with air entrained in the bitumen, floats to the top of the slurry and is withdrawn as a bitumen froth. The remainder of the slurry is then treated further or scavenged by froth flotation techniques to recover bitumen that did not float to the top of the slurry during the separation step. The froth is further treated to separate solids and water from liquid hydrocarbons. Such a process is suggested in U.S. Pat. No. 5,645,714, the disclosure of which is incorporated herein.

U.S. Pat. No. 5,236,577 suggests a high temperature process for treating bitumen froth where a froth is contacted with a diluent at a temperature in the range of 80 to 300. Examples of diluents are naphtha, Varsol, and natural gas condensate. The higher temperature is indicated to improve the rate of separation, and to improve the ultimate product quality, as measured by decreasing the solids and water content of the treated froth.

Canadian patent number 2,232,929, the disclosure of which is incorporated herein, discloses an improvement to the hot water process that utilizes a paraffinic solvent to extract bitumen from the bitumen froth. Asphaltenes have limited solubility in the paraffinic solvent, and so the solvent to bitumen ratios can be adjusted to reject asphaltenes into the tailings stream resulting in a bitumen product with a reduced asphaltene content. The amount of the reduction in asphaltene content can be adjusted to where the bitumen product can be economically processed in hydrocracking operations whereas bitumen produced without reduced ashpaltene contents must be processed in alternative processes, such as cokers.

Very large thickeners are needed for low temperature paraffinic solvent extraction processes for separation of bitumen froths into hydrocarbon and water/mineral solids streams due the low settling rate at low temperatures. Commercial plants may have thickeners with diameters greater than forty meters. Settling rates are much higher for paraffinic processes that operate at higher temperatures and smaller settlers may be utilized in high temperature paraffinic processes. It becomes important to have feed distributors to distribute the solvent-diluted froth into the settler evenly throughout the settler cross-sectional area. An effective feed distributor also minimizes excessive feed stream recirculation in the settler. It is also advantageous to utilize simple feed distributors that do not occupy large portion of the settler cross-sectional area available for separation to take place. Since paraffinic froth treatment processes precipitate a portion of asphaltenes and the asphaltenic solids are sticky, the feed distributors also need to prevent accumulation of asphaltenic solids in the feed distributors.

### SUMMARY OF THE INVENTION

A feed distributor for a settler is provided, the settler effective for separating a bitumen froth into a water/solids stream and a hydrocarbon stream, the feed distributor comprising: an inlet conduit effective to route solvent-diluted bitumen froth into the settler; and an essentially horizontal plate attached to a lower extremity of the inlet conduit and wherein the inlet conduit defines openings through which the solvent-diluted bitumen froth can pass from inside the inlet conduit to a volume above the essentially horizontal plate.

In another aspect of the present invention, a method is provided for separation of a solvent-diluted bitumen froth, the solvent-diluted bitumen forth comprising mineral solids, bitumen, hydrocarbon diluent, and water, the method comprising the steps of: feeding the solvent-diluted bitumen froth into a settler through an inlet conduit: and redirecting vertical flow of solvent-diluted bitumen froth from the inlet conduit to essentially horizontal flow within the settler, the essentially horizontal flow radially outward from a point located near the center of a horizontal cross section of the settler wherein the average velocity of the solvent-diluted bitumen froth leaving the essentially vertical inlet conduit is between one half and twice the velocity of the bitumen froth within the inlet conduit.

In another aspect of the present invention, a method is provided to separate a bitumen product from an oil sand compositions wherein the oil sand composition comprises bitumen containing asphpaltenes, the method comprising the steps of: contacting an oil sand composition with water to form a water and oil sand slurry; separating the water and oil sand slurry into a froth comprising mineral solids, water and hydrocarbon, and an underflow stream comprising solids, water, and entrained hydrocarbons; contacting, at a temperature above 50° C., the froth with a sufficient amount of a paraffinic solvent to reach at least partial asphaltene precipitation to form a solvent-diluted bitumen froth; feeding the solvent-diluted bitumen froth to a settler through a distributor wherein the distributor divides the solvent-diluted bitumen froth into between three and ten streams having essentially equal flow rates and exiting the inlet distributor essentially horizontally and radially outward from a point near the center of the horizontal cross-section of the settler; and separating the solvent-diluted bitumen froth in the settler into a hydrocarbon phase containing a majority of the paraffinic solvent, a majority of the hydrocarbons from the solvent-diluted froth, and a tailings stream containing a majority of solids and a majority of the water present in the froth.

The feed distributor of the present invention is effective to distribute a solvent-diluted bitumen froth evenly across a cross-section of a settler vessel so that the settler's volume is effectively utilized to separate a significant fraction of solids and water from hydrocarbons in the froth mixture. The feed distributor does this with a system that is resistant to accumulation of ashphaltenes and solids in the feed distributor and by maintaining but not accelerating the velocity of the solvent-diluted froth flow into the settler.

### BRIEF DESCRIPTION OF THE FIGURE

FIG. 1 is a cross section of a solvent-diluted bitumen froth settler and inlet distributor acceptable for the practice of the present invention.

FIG. 2 is an isometric view of an embodiment of a feed distributor of the present invention.

FIG. 3 is a process flow drawing for the process of the present invention.

### DETAILED DESCRIPTION OF THE INVENTION

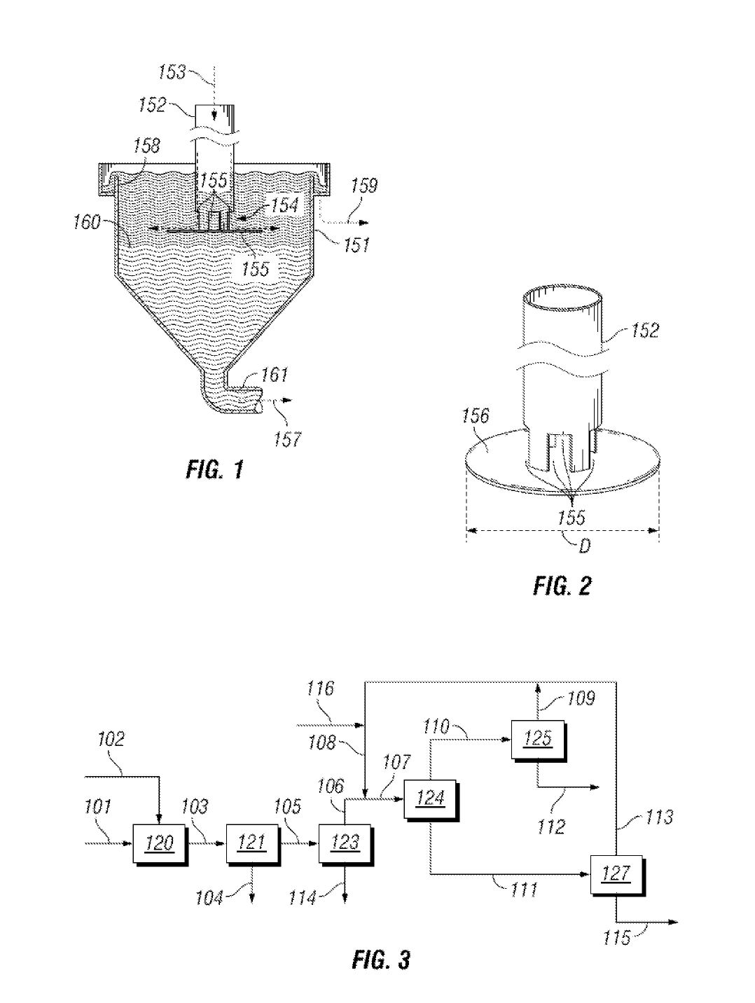

Referring now to FIG. 1, a settler 151 is shown with an inlet conduit 152 entering the settler from above, and effective to route solvent-diluted bitumen froth 153 to a feed distributor 154. The bottom part of inlet conduit may be essentially vertical and could be routed into the settler from above the settler as shown in FIG. 1 or from side of the vessel and then downwards at the center of the vessel via an elbow. The feed distributor defines a plurality of openings 155 through which the solvent-diluted bitumen froth can be passed to enter the settler 151. The feed stream 153 may be a combination of bitumen froth and diluent or diluents with overflow of the 2^{nd} stage settler of, for example, a two-stage counter-current washing settlers. The feed stream 153 may be a combination of diluents and the settler underflow of the 1^{st} stage settler of a two-stage counter-current washing settlers. The diluents may be a paraffinic solvent such as a pentane, hexane, heptanes, octane, or combinations thereof. The diluents may alternatively be a naphtha diluents, or another diluents effective to dissolve bitumen and aid in removal of bitumen from mineral solids. The solvent-diluted bitumen froth feed may advantageously be at a temperature between, for example, 70 and 160° C., but could alternatively be at a lower or higher temperature.

The plurality of openings 155 may be between three and ten openings, and preferably are of essentially equal area and distributed around the circumference of the inlet conduit at a lower extremity of the inlet conduit. In one embodiment of the present invention, there may be four equally spaced openings, with each opening having a width of one eighth of the circumference of the inlet conduit. In an embodiment of the present invention, the combined area of the openings may be between one half and four times a cross sectional area of the inlet conduit, or preferably one to two times a cross sectional area of the inlet conduit. Thus the velocity of the solvent-diluted bitumen forth passing through the openings is not significantly different from the velocity of the solvent-diluted bitumen froth in the inlet conduit. For simplicity of fabrication, the openings may be rectangular in shape. Momentum of the solvent-diluted bitumen froth leaving the openings should be sufficient to distribute the solvent-diluted bitumen froth across the cross-section area of the settler, which can be determined experimentally. For scale modeling experiment, the inlet and vessel Renolds number, the inlet Richardson number, and the relative settling velocity of the solids components can be considered. For various scale experiment, the inlet and vessel Renolds number needs to stay adequately turbulent. Furthermore, the presence of any interface between immiscible fluids can also be considered. The Richardson number reflects the buoyancy force relative to the inertial force and should be matched at various scales of testing. The heavy water-solids-precipitated asphaltene phase causes the feed stream from the feed distributor discharge to deflect downwards, relative to the inertia force which compels it to continue in a horizontal trajectory.

An essentially horizontal plate 156 may be operatively associated with the inlet conduit to redirect flow from the openings defined by the inlet conduit to an essentially horizontal direction, preferably radially outward from the inlet conduit. The inlet conduit is preferably centered in the horizontal cross section of the settler so that the volume of the settler may be most effectively utilized. The essentially horizontal plate 156 may be circular and have a diameter that is between 1.5 and four times the diameter of the inlet conduit. The diameter of the essentially horizontal plate should be sufficient to redirect flow of bitumen froth to an essentially horizontal direction, but should be less than four times the diameter of the inlet conduit because the area occupied by the plate is not effective for separation of the solvent-diluted bitumen froth into separate hydrocarbon and water/solids streams. The maximum plate dimension is also restricted by the potential fouling on the plate if it is too large and velocities drop too low to sweep it clear. The segmented openings at the bottom of the feed distributor are an important feature that divides the flow into streams which prevent the establishment of a pressure gradient which entrains the feed stream into the bottom volume of the feedwell plate if the flow is not divided. The divided feed streams provide open paths for any free hydrocarbons to rise from the bottom part of the settler when the heavy water phase settles downwards.

Solvent-diluted bitumen froth exiting the feed distributor is directed into the settler, where solids and water and precipitated asphaltenes settle and exit the settler from the bottom of the settler as a tailings stream 157. A majority of the bitumen and diluents rise in the settler and overflow a weir 158 around the top outer edge of the settler as a hydrocarbon phase 159. A aqueous-hydrocarbon interface 160 is maintained within the settler, preferably below the essentially horizontal plate 156. The aqueous-hydrocarbon interface is preferably at least one time the feedwell bottome plate diameter below the bottom of the essentially horizontal plate. The lower portion of the settler may be a funnel shape to slowly accelerate solids and water to an outlet 16, from which the water and solids slurry may be pumped, for example, to a tailings solvent recovery unit, for removal of residual diluents from the solids and water stream, and concentration of the solids for disposal.

Referring now to FIG. 2, a feed distributor is shown with an inlet conduit 152 with a essentially horizontal plate 156 attached to the lower extremity of the inlet conduit. The inlet conduit defines openings 155 through which fluids, such as a solvent-diluted bitumen froth, can be routed. The essentially horizontal plate may be round, and may have a diameter D of between 1.5 and four times the diameter of the inlet conduit, d. The essentially horizontal plate could also be accommodated by perforations or could be of a shape other than round, although symmetrical distribution of feed around the settler is preferred.

Referring now to the FIG. 3, an oil sand ore stream, 101, is contacted with water 102 in a mixer 120, to form a water and oil sand slurry 103. The oil sand ore can be a mined bitumen ore from a formation such as oil sands found in the Athabasca area near Fort McMurray, Alberta, Canada. The ratio of oil sand ore to water may be, for example, between the ranges of 1 to 6 and 1 to 2. The oil sands may contain between 75 and 95 percent by weight of mineral solids, and may contain between 10 and 20 percent by weight hydrocarbons. The hydrocarbon portion of the oil sands may have a gravity of between 7 and 10° API and may contain from 10 to 25 percent by weight of asphaltenes. Other components of the hydrocarbon portion of the oil sand ore may be 10 to 40 percent by weight aliphatics, 5 to 20 percent by weight aromatics, and 10 to 50 percent by weight polar compounds. The mixer may agitate the slurry to break up solids and to increase the area of contact between the solids and the water. The mixer may also heat the slurry to a temperature of, for example, between 40 and 90 to enhance separation of the hydrocarbons from the solids. Air and chemicals such as caustic or surfactants may be added to the slurry to further enhance separation of the hydrocarbons from the solids. Alternatively, liberation of hydrocarbon from mineral material may be accomplished in a slurry conditioning transportation line. The water and oil sand slurry optionally may be screened in a screener 121 to remove larger solids 104 from a remaining slurry stream 105.

Remaining slurry stream 105 may be further processed to provide an initial solids separation in a primary separator 123 producing an underflow stream 114, containing solids and water with some bitumen, and a froth 106. The froth contains a majority of the hydrocarbons from the oil sands stream, along with entrained water and solids. Typically, the froth contains about 60 weight percent bitumen, about 30 weight percent water, and about 10 weight percent mineral solids. The primary separator may include additional steps and equipment, such as, for example, flotation cells, to increase the bitumen recovery and de-aerators to remove excessive air.

Froth, 106, from the primary separator may be contacted with a solvent, 108, which may be a paraffinic solvent, to form a solvent-diluted froth mixture 107. The paraffinic solvent may cause at least some of the asphaltenes present in the froth to partition from the hydrocarbon phase into a separate asphaltene phase.

When a paraffinic solvent is utilized, the paraffinic solvent may contain between about 80 and 100 percent by weight of saturated hydrocarbons that do not contain rings. The paraffinic solvent may contain less than about 2 percent by weight of aromatic hydrocarbons and less than about 8 percent by weight cycloparaffins. The paraffinic solvent may include more than 90 percent by weight hydrocarbons having from four to seven carbon atoms, or optionally five or six carbon atoms. In one embodiment of the present invention, the solvent is more than 90 percent by weight pentane. The solvent-diluted froth 107 may be brought to a temperature of above 50° C., between 50° C. and 200° C. or optionally between about 60° C. and 180° C., or between 120° C. and 180° C. These temperatures may be above the softening point of the precipitated asphaltenes under the process conditions. The solvent-diluted froth could be brought to the desired temperature by heating with heat exchangers, direct contact with steam, furnaces, combinations of these, or by other known means. One or more of the solvent and froth streams could be heated sufficiently prior to being mixed so that the combined stream would be in the desired temperature range. The solvent-diluted froth may be held in the desired temperature range for a residence time of between about 1 second and about 30 minutes, or optionally between about 1 second and about five minutes. The froth and solvent may be intimately contacted, for example, by a static mixer or a stirred vessel, either prior to being heated to the desired temperature range, or within the desired temperature range.

A benefit of increased temperatures (above 120° C.). for contacting froth with a paraffinic solvent is that similar bitumen product asphaltene contents may be achieved with considerably lower ratios of solvent to bitumen. For solvents that are at least ninety percent by weight of pentane, hexane, or mixtures thereof, a ration of solvent to bitumen in the froth may be between 1.1 and 2.2. When butane is utilized as the paraffinic solvent, for example when more than fifty percent by weight of the paraffinic solvent is butane, or more than ninety percent by weight butane, the ratio of solvent to bitumen in the may be between 0.7 and 1.7. When the paraffinic solvent comprises at least fifty percent paraffins having a carbon number greater then 7, the ration of paraffinic solvent to bitumen in the froth may be between 1.5 and 3.0.

The solvent-diluted froth stream 107 may be routed to a settler, 124, the settler effective to separate the solvent-diluted froth into a hydrocarbon phase 110 and a tailings stream 111. The hydrocarbon phase contains a majority of the solvent present in the solvent-diluted froth feed, optionally at least 60 percent of the solvent in the solvent-diluted froth feed. The hydrocarbon phase also contains a majority of the non-asphaltene hydrocarbons present in the froth. Optionally, the hydrocarbon phase may contain at least 70 percent to the non-asphaltene hydrocarbons present in the froth stream. The tailings stream may contain a majority of the inorganic solids and a majority of the water present in the froth. In some embodiments of the invention, the tailings stream contains more than 95 percent of the solids present in the froth, and optionally at least 99 percent of the solids from the froth.

Asphaltenes may be partially partitioned from the hydrocarbon phase into a separate asphaltene phase and at least partially rejected into the tailings, or recovered as a separate stream from the settler. This partitioning may be useful when decreasing the asphaltene content of the bitumen increases options for marketing the bitumen. For example, the asphaltenes removed from the bitumen and not recovered with the bitumen product may be between ten and eighty percent of the asphaltenes present in the oil sand composition. The concentration of asphaltenes in the bitumen product may be below about 15 percent by volume, or below about 10 percent by volume, or between 6 and 12 percent by volume

For simplicity, a single settler is shown in the FIG. 3, although it is to be understood that the settler could be a series of separation stages optionally including counter-current contacting with solvent. The settler may optionally be a process that produces three or more products. The three or more products could be the hydrocarbon stream essentially as described above, a stream that contains a majority of the inorganic solids in the solvent-diluted froth and water, and the precipitated asphaltenes. The tailings stream of the present invention would be a combination of the stream containing a majority of the inorganic solids and the stream concentrated in asphaltenes. At least one settler has a distributor through which feed to the settler flows, wherein the distributor divides the solvent-diluted bitumen froth into between three and ten streams having essentially equal flow rates and exiting the inlet distributor essentially horizontally and radially outward from a point near the center of the horizontal cross-section of the settler.

Recycle solvent 109 may be recovered from the hydrocarbon stream 110 in a solvent recovery unit 125, leaving a bitumen product 112. The bitumen product may have less than about 15 percent by weight asphaltene content, and less than 1 percent by weight water content. Some solvent may optionally remain in the bitumen product, for example, to facilitate pipeline transportation of the bitumen product.

Tailings 111 may be processed in a tailings solvent recovery unit 127 to remove at least a portion of the solvent present in the tailings stream 113 and a solvent free tailings stream 115. The recovered solvent from the tailings solvent recovery unit 113 may be combined with recycle solvent and make-up solvent 116 to form the solvent stream 108.

The solvent recovery unit 125 may use known methods to remove more volatile hydrocarbons from less volatile hydrocarbons such as distillation and supercritical solvent separation. The tailings solvent recovery unit may utilize known methods to remove volatile hydrocarbons from solids and/or aqueous streams such as using the heat present in the tailings stream for vaporization of the solvent.

Water in the tailings may be at least partially separated from the solids and recycled, for example, to the slurry of oil sand slurry 103. Recycling water from the tailings reduces the need to provide additional water 102. Recycling this water as hot water also provides additional heat to the front-end water extraction process and improves energy efficiency of the overall process. Alternatively, at least a portion of the heat in the tailing stream 115 can be recovered using heat exchangers before the tailings stream 115 is sent, for example, to a tailings pond.

What is claimed is:

1. A feed distributor for a settler, the settler effective for separating a solvent-diluted bitumen froth into a water/solids stream and a hydrocarbon stream, the feed distributor comprising:
an inlet conduit effective to route bitumen froth into the settler; and
an essentially horizontal plate attached to a lower extremity of the inlet conduit and wherein the inlet conduit defines openings through which the bitumen froth can pass from inside the inlet conduit to a volume above the essentially horizontal plate.

2. The feed distributor of claim 1 wherein the openings defined by the inlet conduit comprise a plurality of openings distributed around the inlet conduit.

3. The feed distributor of claim 2 wherein the plurality of openings are distributed around the inlet conduit at the lower extremity of the inlet conduit.

4. The feed distributor of claim 3 wherein the openings have a total area of between about one half and four times the cross sectional area of the inlet conduit.

5. The feed distributor of claim 1 where in the openings are partially defined by an upper surface of the essentially horizontal plate.

6. The feed distributor of claim 4 wherein number of openings is between three and ten.

7. The feed distributor of claim 4 wherein the openings are equally spaced around the outside of the inlet conduit.

8. The feed distributor of claim 4 wherein the openings are essentially equally sized rectangular openings.

9. The feed distributor of claim 2 wherein the essentially horizontal plate has an area of between two and sixteen times the cross sectional area of the essentially vertical inlet conduit.

10. A method for separation of a solvent-diluted bitumen froth, the solvent-diluted bitumen forth comprising mineral solids, bitumen, hydrocarbon diluent, and water, the method comprising the steps of:
feeding the solvent-diluted bitumen froth into a settler through an inlet conduit: and
redirecting vertical flow of solvent-diluted bitumen froth from the inlet conduit to essentially horizontal flow within the settler, the essentially horizontal flow radially outward from a point located near the center of a horizontal cross section of the settler wherein the average velocity of the solvent-diluted bitumen froth leaving the essentially vertical inlet conduit is between one half and twice the velocity of the bitumen froth within the inlet conduit.

11. The method of claim 10 wherein the radially outward flow is initially a plurality of essentially equal portions of the solvent-diluted bitumen froth.

12. The method of claim 11 wherein the plurality of essentially equal portions of the solvent-diluted bitumen froth is between three and ten essentially equal portions.

13. The method of claim 11 wherein a hydrocarbon-aqueous phase interface is maintained at least one time the feed distributor horizontal plate diameter below the initial essentially horizontal flow of solvent-diluted bitumen froth.

14. A method to separate a bitumen product from an oil sand compositions wherein the oil sand composition comprises bitumen containing asphpaltenes, the method comprising the steps of:
contacting an oil sand composition with water to form a water and oil sand slurry;
separating the water and oil sand slurry into a froth comprising mineral solids, water and a hydrocarbon phase, and an underflow stream comprising solids, water, and entrained hydrocarbons;
contacting, at a temperature above 50° C., the froth with a sufficient amount of a paraffinic solvent to reach at least partial asphaltene precipitation to form a solvent-diluted bitumen froth;
feeding the solvent-diluted bitumen froth to a settler through a distributor wherein the distributor divides the solvent-diluted bitumen froth into between three and ten streams having essentially equal flow rates and exiting the inlet distributor essentially horizontally and radially outward from a point near the center of the horizontal cross-section of the settler; and
separating the solvent-diluted bitumen froth in the settler into a hydrocarbon phase containing a majority of the paraffinic solvent, a majority of the hydrocarbons from the solvent-diluted froth, and a tailings steam containing a majority of solids and a majority of the water present in the froth.

15. The method of claim 14 wherein a hydrocarbon-aqueous phase interface is maintained at least the diameter of the horizontal plate diameter below the bottom of the initial essentially horizontal flow of solvent-diluted bitumen froth.
